(19) United States
(12) Patent Application Publication
(10) Pub. No.: US 2009/0269448 A1
(43) Pub. Date: Oct. 29, 2009

(54) CHOCOLATE CONFECTION AND METHOD OF MAKING CHOCOLATE CONFECTIONS

(76) Inventor: ELIZEBETH A. SUNDBERG, Northeast Grafton, ND (US)

Correspondence Address: James Ray & Associates, 2640 Pitcairn Road, Monroeville, PA, 15146, US

(21) Appl. No.: 12/429,277

(22) Filed: Apr. 24, 2009

Related U.S. Application Data
(60) Provisional application No. 61/047,859, filed on Apr. 25, 2008.

(51) Int. Cl. A23G 3/54; A23G 3/20

(52) U.S. Cl. 426/103; 426/279

(57) ABSTRACT

A chocolate confection includes an edible outer shell having a predetermined size and a predetermined shape formed from a first plurality of predetermined ingredients and an edible center formed from a second plurality of predetermined ingredients.

### CROSS REFERENCE TO RELATED APPLICATION

This patent application is related to and claims priority from U.S. Provisional Patent Application Ser. No. 61/047,859 filed Apr. 25, 2008.

### FIELD OF THE INVENTION

The present invention relates, in general, to candy and, more particularly, this invention relates to chocolate confections and a method of making a plurality of chocolate confections.

### BACKGROUND OF THE INVENTION

Prior to the conception and development of the present invention, candy, as is generally well known in the prior art, has been enjoyed by people all over the world. In particular, chocolate is one of the most popular types of candies. Truffles are confections made from chocolate which are considered to be of the highest quality of chocolate confections. Due to the popularity of chocolate confections, companies and individuals are constantly seeking to find improved methods of making chocolate confections, such as truffles, and seeking to gratify their taste buds with the quality chocolate confections made from such improved methods.

### SUMMARY OF THE INVENTION

The present invention provides a chocolate confection. Such chocolate confection includes an edible outer shell having a predetermined size and a predetermined shape formed from a first plurality of predetermined ingredients and an edible center formed from a second plurality of predetermined ingredients.

According to another embodiment, method of making a plurality of chocolate confections is provided. Such method includes providing a candy template having a predetermined plurality of molds disposed at least one of therein, thereon, and a combination thereof for filling with predetermined ingredients, melting between about 1.66 cups and about 2.0 cups of predetermined white chocolate and between about 1.0 tablespoon and about 1.5 tablespoons of shortening in a predetermined container, stirring a predetermined amount of toasted crushed coconut into such melted white chocolate and shortening until thoroughly mixed to form an outer shell mixture, brushing a predetermined amount of such outer shell mixture over a bottom wall and sides walls of each of such plurality of molds, placing such candy template into at least one of a freezer and a refrigerator for a predetermined amount of time such that such outer shell mixture solidifies to a predetermined degree thereby forming empty shells for filling, heating 0.5 cups of heavy whipping cream and 2.0 tablespoons butter to a predetermined temperature, stirring 1 cup of predetermined semi-sweet chocolate chips and 0.5 teaspoons vanilla into such heavy whipping cream and melted butter until such semi-sweet chocolate chips are melted and such semi-sweet chocolate chips, such vanilla, such heavy whipping cream, and such melted butter is thoroughly blended thereby forming a chocolate filling mixture, placing a predetermined amount of such chocolate filling mixture within each of such empty shells thereby yielding a predetermined number of filled shells, placing such filled shells within at least one of a refrigerator and freezer until such chocolate filling mixture has solidified to a predetermined degree, covering an exposed portion of such chocolate filling within such filled shells with a layer of such white chocolate mixture to completely form a plurality of chocolate confections, placing such candy template within at least one of a refrigerator and freezer until such layer of white chocolate mixture has solidified to a predetermined degree such that such chocolate confections may be removed from such candy template and maintain their shape, and removing such chocolate confections from such candy template.

### OBJECTS OF THE INVENTION

It is, therefore, one of the primary objects of the present invention to provide a chocolate confection which provides optimal taste.

Another object of the present invention is to provide an improved method of making chocolate confections which will yield a predetermined amount of delicious truffles.

Still another object of the present invention is to provide a plurality of quality chocolates which will gratify even the most discerning of chocolate lovers.

Yet another object of the present invention is to provide a chocolate confection which combines a toasted coconut and chocolate based outer shell, and a smooth melt-in-your mouth semi-sweet chocolate based center.

An additional object of the present invention is to provide a method of making chocolate truffles which yields truffles which boast an improved taste, quality, and appearance.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a cross-sectional view taken along the lines II-II of FIG. 1.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

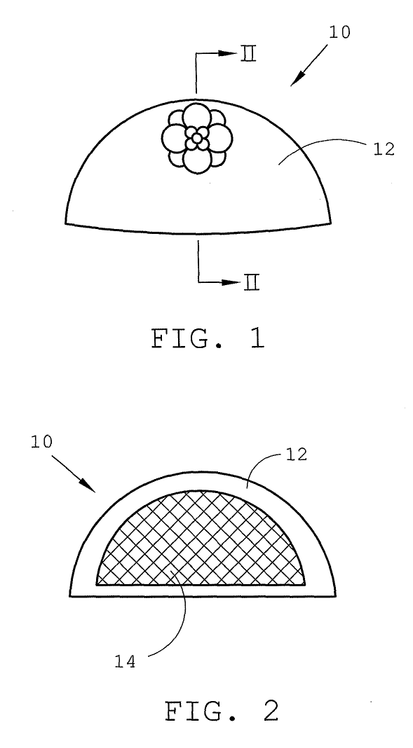

Reference is now made, more particularly, to FIGS. 1-2.

A chocolate confection, generally designated 10, includes an edible outer shell 12 having a predetermined size and a predetermined shape formed from a first plurality of predetermined ingredients and an edible center 14 formed from a second plurality of predetermined ingredients.

It is presently preferred that such first plurality of predetermined ingredients includes a predetermined amount of white chocolate and a predetermined amount of shortening.

Such predetermined amount of white chocolate is preferably between about 1.5 cups and about 2.0 cups. Although any white chocolate may be used, it is presently preferred that such white chocolate is Ghiradelli™ white chocolate manufactured by the Ghiradelli Chocolate Company, this company has a mailing address of 1111 139^{th} Avenue, San Leandro, Calif., 94578 and has a website at “www. Ghirardelli.com”.

Such predetermined amount of shortening is preferably between about 0.5 tablespoons and 1.5 tablespoons.

It is further presently preferred that such first plurality of predetermined ingredients further includes a predetermined amount of coconut. It is presently preferred that such coconut is at least one of toasted, crushed, and a combination thereof. It is further presently preferred that such predetermined amount of coconut is between about 0.33 cups and about 0.66 cups.

It is presently preferred that such second predetermined plurality of ingredients includes a predetermined amount of semi-sweet chocolate and at least one of a predetermined amount of whipping cream, a predetermined amount of butter, a predetermined amount of vanilla, and a combination thereof. It is presently preferred that such second predetermined plurality of ingredients includes a combination of semi-sweet chocolate a predetermined amount of whipping cream, a predetermined amount of butter, and a predetermined amount of vanilla.

Such predetermined amount of semi-sweet chocolate is preferably between about 0.75 cups and about 1.25 cups.

Such predetermined whipping cream is preferably heavy whipping cream and such predetermined amount of such whipping cream is presently preferred to be between about 0.33 cups and about 0.66 cups.

Such predetermined amount of butter is preferably between about 0.75 tablespoon and about 2.25 tablespoons.

Such predetermined amount of vanilla is between about 0.25 teaspoons and about 0.75 teaspoons.

According to another embodiment, a method of making a plurality of chocolate confections is provided. Such method includes providing a candy template having a predetermined plurality of molds disposed at least one of therein, thereon, and a combination thereof for filling with predetermined ingredients, melting between about 1.66 cups and about 2.0 cups of predetermined white chocolate and between about 1.0 tablespoon and about 1.5 tablespoons of shortening in a predetermined container, stirring a predetermined amount of toasted crushed coconut into such melted white chocolate and shortening until thoroughly mixed to form an outer shell mixture, brushing a predetermined amount of such outer shell mixture over a bottom wall and sides walls of each of such plurality of molds, placing such candy template into at least one of a freezer and a refrigerator for a predetermined amount of time such that such outer shell mixture solidifies to a predetermined degree thereby forming empty shells for filling, heating 0.5 cups of heavy whipping cream and 2.0 tablespoons butter to a predetermined temperature, stirring 1 cup of predetermined semi-sweet chocolate chips and 0.5 teaspoons vanilla into such heavy whipping cream and melted butter until such semi-sweet chocolate chips are melted and such semi-sweet chocolate chips, such vanilla, such heavy whipping cream, and such melted butter is thoroughly blended thereby forming a chocolate filling mixture, placing a predetermined amount of such chocolate filling mixture within each of such empty shells thereby yielding a predetermined number of filled shells, placing such filled shells within at least one of a refrigerator and freezer until such chocolate filling mixture has solidified to a predetermined degree, covering an exposed portion of such chocolate filling within such filled shells with a layer of such white chocolate mixture to completely form a plurality of chocolate confections, placing such candy template within at least one of a refrigerator and freezer until such layer of white chocolate mixture has solidified to a predetermined degree such that such chocolate confections may be removed from such candy template and maintain their shape, and removing such chocolate confections from such candy template.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A chocolate confection comprising:
a. an edible outer shell having a predetermined size and a predetermined shape formed from a first plurality of predetermined ingredients; and
b. an edible center formed from a second plurality of predetermined ingredients.

2. A chocolate confection according to claim 1 wherein said first plurality of predetermined ingredients includes a predetermined amount of white chocolate and a predetermined amount of shortening.

3. A chocolate confection according to claim 2 wherein said predetermined amount of white chocolate is between about 1.5 cups and about 2.0 cups.

4. A chocolate confection according to claim 2 wherein said predetermined amount of shortening is between about 0.5 tablespoons and 1.5 tablespoons.

5. A chocolate confection according to claim 2 wherein said white chocolate is Ghiradelli™ white chocolate.

6. A chocolate confection according to claim 2 wherein said first plurality of predetermined ingredients further includes a predetermined amount of coconut.

7. A chocolate confection according to claim 6 wherein said coconut is at least one of toasted, crushed, and a combination thereof.

8. A chocolate confection according to claim 6 wherein said predetermined amount of coconut is between about 0.33 cups and about 0.66 cups.

9. A chocolate confection according to claim 1 wherein said second predetermined plurality of ingredients includes a predetermined amount of semi-sweet chocolate and at least one of a predetermined amount of whipping cream, a predetermined amount of butter, a predetermined amount of vanilla, and a combination thereof.

10. A chocolate confection according to claim 9 wherein said second predetermined plurality of ingredients includes a predetermined amount of semi-sweet chocolate, a predetermined amount of whipping cream, a predetermined amount of butter, a predetermined amount of vanilla.

11. A chocolate confection according to claim 10 wherein said predetermined amount of semi-sweet chocolate is between about 0.75 cups and about 1.25 cups.

12. A chocolate confection according to claim 10 wherein said whipping cream is heavy whipping cream.

13. A chocolate confection according to claim 10 wherein said predetermined amount of whipping cream is between about 0.33 cups and about 0.66 cups.

14. A chocolate confection according to claim 10 wherein said predetermined amount of vanilla is between about 0.25 teaspoons and about 0.75 teaspoons.

15. A chocolate confection according to claim 10 wherein said predetermined amount of butter is between about 0.75 tablespoon and about 2.25 tablespoons.

16. A method of making a plurality of chocolate confections comprising:
a. providing a candy template having a predetermined plurality of molds disposed at least one of therein, thereon, and a combination thereof for filling with predetermined ingredients;
b. melting between about 1.66 cups and about 2.0 cups of predetermined white chocolate and between about 1.0 tablespoon and about 1.5 tablespoons of shortening in a predetermined container;
c. stirring a predetermined amount of toasted crushed coconut into said melted white chocolate and shortening until thoroughly mixed to form an outer shell mixture;
d. brushing a predetermined amount of said outer shell mixture over a bottom wall and sides walls of each of said plurality of molds;
e. placing said candy template into at least one of a freezer and a refrigerator for a predetermined amount of time such that said outer shell mixture solidifies to a predetermined degree thereby forming empty shells for filling;
f. heating 0.5 cups of heavy whipping cream and 2.0 tablespoons butter to a predetermined temperature;
g. stirring 1 cup of predetermined semi-sweet chocolate chips and 0.5 teaspoons vanilla into said heavy whipping cream and melted butter until said semi-sweet chocolate chips are melted and said semi-sweet chocolate chips, said vanilla, said heavy whipping cream, and said melted butter are thoroughly blended thereby forming a chocolate filling mixture;
h. placing a predetermined amount of chocolate filling mixture within each of said empty shells thereby yielding a predetermined number of filled shells;
i. placing said filled shells within at least one of a refrigerator and freezer until said chocolate filling mixture has solidified to a predetermined degree;
f. covering an exposed portion of said chocolate filling within said filled shells with a layer of said white chocolate mixture to completely form a plurality of chocolate confections;
g. placing said candy template within at least one of a refrigerator and freezer until said layer of white chocolate mixture has solidified to a predetermined degree such that said chocolate confections may be removed from said candy template and maintain their shape; and
h. removing said chocolate confections from said candy template.
